(19) United States
(12) Patent Application Publication
(10) Pub. No.: US 2003/0040995 A1
(43) Pub. Date: Feb. 27, 2003

(54) Benefit provider system and method

(76) Inventors: Donato V. Daddario, Randolph, NJ (US); Yahping Wang, Belle Mead, NJ (US)

Correspondence Address: Leslie Gladstone Restaino, Brown Raysman Millstein Felder and Steiner, 4th Floor, 55 Madison Avenue, Morristown, NJ, 07960, US

(21) Appl. No.: 09/935,981

(22) Filed: Aug. 23, 2001

(51) Int. Cl. G06F 17/60

(52) U.S. Cl. 705/35; 705/37

(57) ABSTRACT

A benefits system is provided comprising: an employer system accessible by an employee; and a benefit provider system accessible from the employer system wherein the benefit provider system includes an interface system for accessing a plurality of service systems including at least an employer corporate stock plan system and a retirement plan system. The benefit system provides a single point of access for numerous systems and thus affords consolidated benefit information.

### BACKGROUND OF THE INVENTION

1. Field of the Invention

The present invention relates to employee benefits; and more particularly, to computer-implemented systems for providing employee benefit information.

2. Description of the Prior Art

Numerous employers provide their employees with diverse financial remunerations such as corporate stock and retirement benefits. Many employees are, however, confused or uninformed about the status and/or benefit operation, and as a result, tend to under-utilize their financial packages.

Recognizing the inefficiency of providing and monitoring financial employee benefit packages, employers often turn to outside financial service corporations to provide employees benefit information. Typically, financial service corporations utilize a number of disparate tools to provide employee benefit information. This causes employees to receive a hodgepodge of financial data, which is often difficult to interpret. One common example is the use of monthly statements. Monthly statements can be confusing, particularly where each benefit package component has a separate statement. For example, it is not uncommon for an employee to receive a corporate stock plan statement, a retirement plan statement, a general stock portfolio statement, and the like. In this instance, combined statements may be impossible as each benefit may have a separate tracking system.

The financial industry has identified the need to automate financial services. For example, the American Express “My Retirement Account” Web site discloses an online employer-sponsored retirement plan account system accessible by an employee. In this system, each employer-sponsored plan, or plan benefit, has a separate system, causing an employee to use and remember a myriad of different identifications and passwords to gain access to his or her benefit information. As another example, the American Express “Financial Services” Web site discloses a user access selection for multiple accounts.

Accordingly, there is a need for an integrated system for providing consolidated employee benefit information. It would be particularly useful if such a system could simultaneously access numerous benefit systems via a single identification procedure. Access of real-time market data in order to understand current financial package status would also be beneficial.

### SUMMARY OF THE INVENTION

In accordance with the present invention, there is provided an employer system accessible by an employee; and a benefit provider system accessible from the employer system wherein the benefit provider system includes an interface system for accessing a plurality of service systems including at least an employer corporate stock plan system and a retirement plan system.

Advantageously, the benefit system described herein provides a single sign-on for accessing numerous employee benefit or service systems; thus, employees can obtain or attain consolidated benefit information. As another advantage, the system also integrates a number of other tools such as financial planning, security trading, access to market data and research, and the like.

Another aspect of the invention is a means for connecting the user, via a single sign-on procedure, to at least two service systems including a retirement plan system; and a corporate stock plan system; and means for delivering content from the service systems to the user.

In another aspect of the invention there is provided a method of accessing user benefit information comprising the steps of accessing a benefit provider system; interfacing the benefit provider system with a plurality of service systems including at least a corporate stock plan system and a retirement plan system; and selectively displaying information from at least one service system to a user. This provides a streamlined, efficient process by which an employee may easily obtain benefit information via a single identification procedure.

### BRIEF DESCRIPTION OF THE DRAWINGS

The invention will be more fully understood and further advantages will become apparent when reference is made to the following detailed description of the preferred embodiments of the invention and the accompanying drawings, in which:

FIG. 1 is a block diagram of an employee benefits system;

FIGS. 2-4 are system flow diagrams depicting operation of an employee benefits provider system;

FIG. 5 is a video screen display illustrating a system sign-on;

FIG. 6 is a video screen display of a start interface of a browser interface for the system of FIG. 1;

FIG. 7 is a video screen display depicting a part of a corporate stock plan interface;

FIG. 8 is a video screen display illustrating a part of a retirement plan interface;

FIG. 9 is a video screen display illustrating a part of a market data interface; and

FIG. 10 is a flow diagram of a method for accessing employee benefit information.

### DETAILED DESCRIPTION OF THE INVENTION

The present invention provides systems and tools which provide consolidated employee benefit information via a single identification procedure. Employees are able to understand current financial package status via access to real-time market data, thereby allowing for more informed decision-making. In addition, the systems integrate a myriad of financial tools such as financial planning, access to market data and research, and the ability to conduct security trades.

Generally stated, the present invention provides an employer system accessible by an employee; and a benefit provider system accessible from the employer system wherein the benefit provider system includes an interface system for accessing a plurality of service systems including at least an employer corporate stock plan system and a retirement plan system.

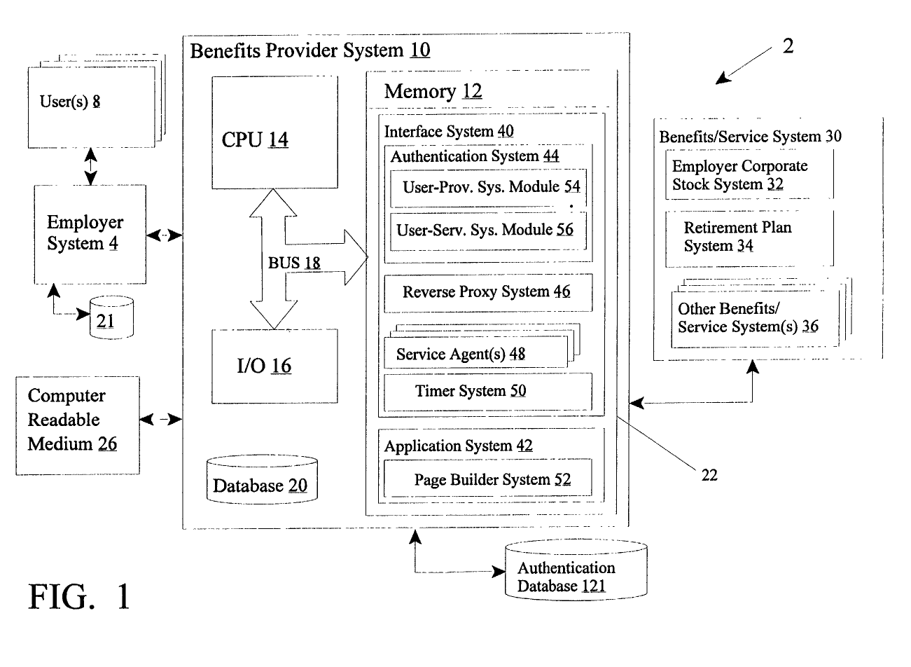

Turning now to FIG. 1, an overview of a benefit system in accordance with the present invention is provided. For purposes of this disclosure, a “user” may be any individual or entity that uses benefit system 2, and, preferably, an individual or entity to which benefits are provided; for example, an employee of the employer. A “user” may also include a computer-based device of a user. “Benefits,” as used herein, preferably include finance-related benefits such as employee corporate stock plans (e.g., stock option and purchase plans, and stock grants), retirement savings plans (e.g., 401(k) plans), pension plans, financial service tools and the like. “Employer,” includes any individual or entity that provides benefits to those that work for the individual or entity, e.g., users. “Information” includes any content available via provider system 10 to a user 8.

Employer system 4 may be any computer-based employer system that is accessible by user 8. Notably, employer system 4 may be configured to provide a variety of functions to user 8, which are not relevant to this description. In accordance with the invention, however, employer system 4 includes means to selectively connect user 8 to benefits provider system 10. The hardware employed by employer system 4 is preferably similar to benefits provider system 10, as described below. Accordingly, the description of computer structure, excepting of course program product 22 that follows, is equally applicable to employer system 4 and benefits provider system 10.

Benefits provider system 10 (“provider system 10”) is a computer system of an entity, e.g., a financial service corporation that provides employee benefits. Preferably, provider system 10 provides benefit information via a service system interface 30. Provider system 10 preferably includes a memory 12, a CPU 14, input/output devices (I/O) 16 and a bus 18. Databases 20, 21, 121, as will be described in more detail below, may also be provided. Memory 12 preferably includes a program product 22 that, when executed by CPU 14, comprises various functional capabilities described in further detail below. Memory 12 (and databases) may comprise any known or hereinafter developed type of data storage system and/or transmission media such as magnetic media, optical media, random access memory (RAM), read only memory (ROM), a data object, and the like. Moreover, memory 12 (and databases) may reside at a single physical location comprising one or more types of data storage, or be distributed across a plurality of physical systems. CPU 14 may likewise comprise a single processing unit, or a plurality of processing units distributed across one or more locations, e.g., on a client and server. I/O 16 may comprise any known or hereinafter developed type of input/output device including a network system, modem, keyboard, mouse, voice recognition system, CRT, printer, disc drives, etc. Additional components, such as cache memory, communication systems, system software, etc., may also be incorporated.

Provider system 10 may reside on a personal computer that may or may not be part of a computer network. However, as recognized in the field, provider system 10 preferably includes one or more central computers, i.e., servers. Here, satellite servers (not shown) may each contain only one system with the remainder of the systems resident on a centrally located server. In another embodiment, a number of servers may be present in a central location, each having different software applications resident therein. Alternatively, a number of servers may reside in a central location, each containing all of the systems/modules resident therein. A server computer typically comprises an advanced mid-range multiprocessor-based server, such as the Ultra II from Sun Microsystems or the RS6000 from IBM, utilizing standard operating systems, software written in C++, Java or a similar language, which is designed to drive the operation of the particular hardware and which is compatible with other system components, and I/O controllers. A personal computer may typically comprise an INTEL PENTIUM III microprocessor, or like processor, such as found in a Dell Dimensions XTS T450 computer.

In the following discussion, it will be understood that the method steps discussed preferably are performed by processor 14 executing instructions of program product 22 stored in memory 12, such as instructions of interface system 40. Program product 22 can be initially loaded into memory from a computer readable medium 26. It is understood that the various devices, modules, mechanisms and systems described herein may be realized in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

Program product 22 in accordance with the invention preferably includes an interface system 40 and an application system 42. Interface system 40 includes an authentication system 44, a reverse proxy system 46, a service agent(s) 48, and a timer system 50. Application system 42 includes, inter alia, a page builder system 52.

In a preferred embodiment, a user 8 accesses provider system 10 via employer system 4. Connection to employer system 4 may be made by any feasible means such as by direct connection, the Internet, etc. Preferably, employer system 4 is accessed via the Internet with a conventional browser such as Microsoft Internet Explorer or Netscape Navigator. Access to provider system 10 may then be made via a hypertext link in a Web site of the employer system 4. Where user 8 is connected to system 2 via the Internet, connectivity is preferably provided by conventional TCP/IP sockets-based protocol. In this instance, an Internet service provider outside system 2 would provide connectivity to a system server within system 2.

As an alternative to connection through employer system 4, a user 8 may also access provider system 10 directly. In this case, user 8 and system 10 may be connected via the Internet, wide area networks (WAN), local area networks (LAN) or other private networks. The server and client may utilize conventional token ring connectivity for WAN, LAN, or other private networks, or Ethernet, or other conventional communications standards.

With special regard to databases 20, 21, 121, system 10 preferably includes a user or application database 20 that records and stores employee and application specific data. Exemplary data may include an employee stock watch list and questionnaire results. Database 20 may be a conventional relational database system such as Oracle or Sybase. Another preferred database is an authentication/entitlement (“A/E”) database 21, 121 that records and stores user 8 identification and passwords, entitlement levels and user specific data such as a social security number, employee identification number, etc. Access for a particular employer may also be limited to, for example, the benefits to which the employer subscribes for its employees. Accordingly, an employer may also have an entitlement level stored in A/E database(s) 21, 121 of system 2. A/E database 21, 121 may also record and store and maintain the cookies; e.g., specific user information. A/E database 21, 121, as indicated, may be accessible as part of employer system 4 and/or as an external database of system 10. Preferably, A/E database 21, 121 does not reside in the same physical machine(s) as system 10. Placement of A/E database with employer system 4 provides the employer with the ability to monitor user 8 accessibility and may provide for quicker access. It should be emphasized that user application database 20 and/or A/E database 21, 121 may be partitioned, if necessary, to include numerous databases.

With the foregoing overview in mind, reference is made back to FIG. 1. Benefit or service systems 30 (collectively “service system 30”) may include a plurality of systems that provide specific employee benefit information. Preferably, the benefit systems of service system 30 include a corporate stock plan system 32 that provides information regarding an employer's corporate stock plan and an employee's participation therein, and a retirement plan system 34 for providing information regarding an employee's retirement plan, e.g., 401(k) plan.

Other benefit/service systems 36 may also be provided. One example of another service system 36 may be an online transaction forum through which user 8 may conduct security transactions.

While service system 30 is shown as remote to provider system 10, it may be incorporated as a local component thereof. However, circumstances may require that other service systems 36 are external; as, for example, where real time market data is provided by the REUTERS QUOTRON server. In those cases where service system 30 is external, interface system 40 retains the necessary provider system 10 identifiers and user identifiers for accessing service systems 30, as will be described below.

As mentioned above, benefits provider system 10 includes a program product 22 having an interface system 40 and an application system 42. Interface system 40 provides authentication processing, delivering hypertext markup language (HTML) pages to user 8, processing forms submitted by user 8, and performing secure socket layer (SSL) connectivity between service system 30 and user 8. Advantageously, interface system 40 provides a means for user 8 to use various Web sites, e.g., service system 30. Application system 42 interfaces with interface system 40 to handle certain dynamic content Web requests such as servlets, JavaScript pages, and the like.

More specifically, interface system 40 includes authentication system 44, reverse proxy system 46, server agent(s) 48 and timer system 50.

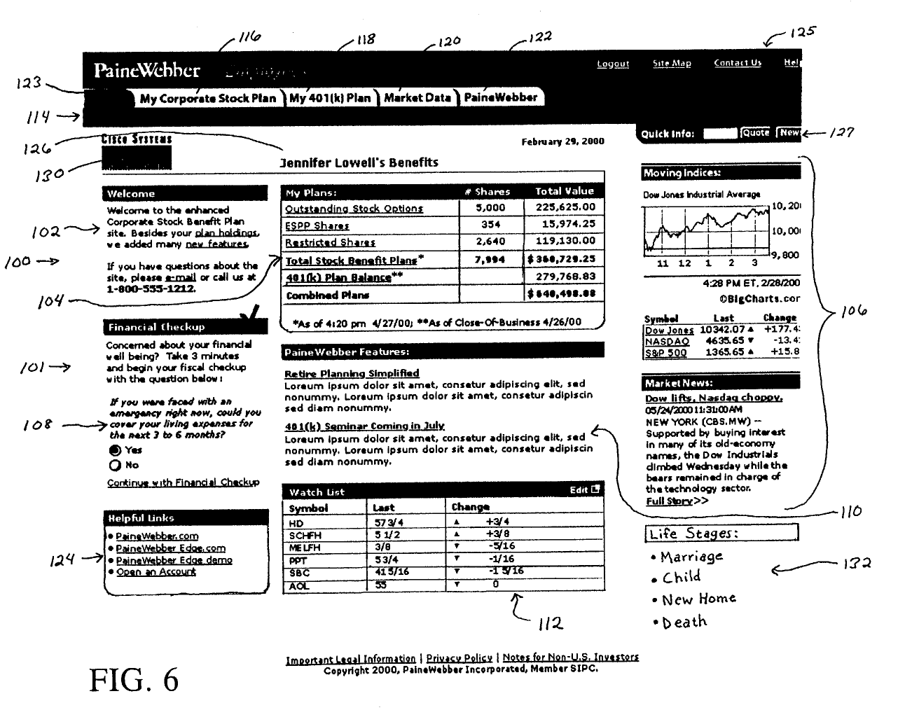

Authentication system 44 preferably includes two general authentication modules that operate in conjunction with other systems 46, 48, 50 to connect a user, via a single sign-on process, to at least two service systems. The modules include a user-provider system module 54 that logs in and continually authenticates user 8 to system 10, and a user-service system module 54 that logs in and continually authenticates user 8 and system 10 to service systems 30. Any service system 30 that user 8 is entitled to access is predetermined by entitlement level, and system 10 provides a suite of features in accordance therewith. Authentication system 44 uses the user's 8 entitlement level to access necessary service systems 30 and information resident on provider system 10 so that a browser interface 100 (FIGS. 6-9) may be built, as described below. A user entitlement level contains a list of systems, modules, mechanisms, applications or functions (collectively “features”) that user 8 is allowed to access depending on the user's respective benefit package(s), e.g., corporate stock plan, retirement savings plan, financial service, etc. Of course, some features may be universally available. Features can be added or deleted to a user's entitlement level as necessary. All security updates, new users, features, adds or changes, may require secondary approval before processing. It should be recognized that while the description will explain operation in terms of user 8 having a single entitlement level, a user may have a number of entitlement levels, e.g., one for a corporate stock plan and another for a retirement plan.

Authentication system 44 also represents a single point of security control for adding or removing a user from provider system 10. Preferably, authentication system 44 is resident in more than one server of system 10 in order to provide load balancing and disaster recovery.

Reverse proxy system 46 handles use of 8 browser requests. In particular, reverse proxy system 46 allows seamless access to information from system 10 (and service system 30) by analyzing a request for information and determining concomitant availability and location. Requests for local information provided via system 10 from database 20. Advantageously, requests for remote information cause reverse proxy system 46 to request information from at least one of service system 30 and forward the results to user 8 in a seamless fashion, i.e., so that user 8 cannot determine origination of the information.

In order to provide such transparent information, reverse proxy system 46 uses forward mapping techniques where a request for information is made. For example, “ubspainewebber.com” is forwarded to service system 30 by mapping the uniform resource locator (URL) thereto, e.g., <ubspainewebber.com>. To prevent the bypass of interface system 40 and reverse proxy system 46 by links embedded in the HTML sections of service system 30, service system HTML section links are set to allow reverse proxy system 46 to determine the originating service system 30 by maintaining all embedded links as non-complete URLs. Certain static items, such as images and plain HTML pages, may be cached in reverse proxy system 46 to increase performance. Reverse proxy system 46 also provides a “single point of contact” system for all requests regardless of nature. This makes redundancy and scalability possible. For example, if the load on a server increases, the addition of another server can be utilized to increase service throughput. As a result, load-balancing tools such as LOCALDIRECTOR from CISCO or NETWORK DISPATCHER from IBM, may route requests to less busy servers. Reverse proxy system 46 also allows for the purchase and installation of one provider system certificate, provides a standard port for secured socket layers (SSL) to assure proper usage through firewalls and affords high volume and availability.

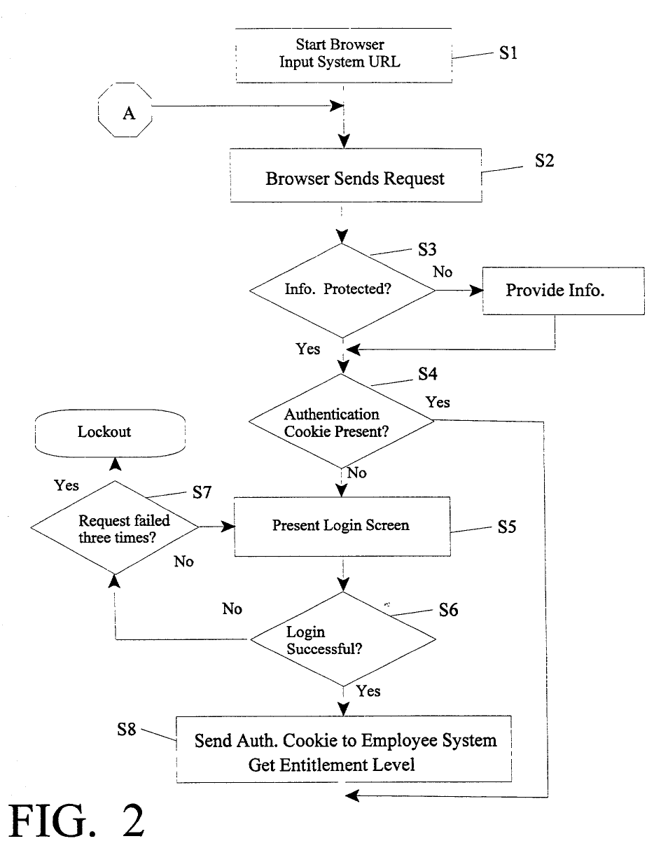

Referring to FIGS. 2-4, interface system logic is shown in detail. As shown in FIG. 2, at step S1, user 8 starts his or her browser and establishes communication by, for example, selecting a hypertext link selection on a Web page of employer system 4 that calls up a uniform resource locator (URL) of provider system 10. Alternatively, user 8 directly accesses provider system 10, e.g., by entering the provider system 10 URL into their browser. In any event, a URL may vary depending on a number of factors such as employer, user 8 and/or geography. For instance, in the preferred case of access through employer system 4, a user 8 in New York City will be given a URL to access a server of employer system 4 in or near New York City, while a user 8 in Los Angeles will be given a different URL.

At step S2, user 8 may enter a request for information by selecting a hypertext link from a displayed Web page. In the case where user 8 is signing on, entry of the system URL is the request.

Logic branches at step S3 where authentication system 44 determines if the requested information is protected. In a preferred setting, all information, except public content and/or help is protected, and in order for user 8 to retrieve such information, he or she must sign in as described below. In the case where user 8 is signing on, the determination is “protected.”

When information is protected, authentication system 44 activates user-provider system module 54 at S4, which determines whether an authentication cookie or indicator is present on a user's system. An authentication cookie's presence on the user's system indicates that user 8 has already been authenticated and prevents user 8 from multiple sign-ons after each request for information. The authentication cookie provides the means for authentication system 44 to maintain authentication between information requests, i.e., hypertext transfer protocol (HTTP) transactions. In addition, the authentication cookie allows authentication system 44 to access user data such as the name, entitlement level and service system identifications and passwords (if applicable). Further, if a request is made for information from service system 30, authentication system 44, in conjunction with other interface system components 46, 48, 50 and application system 42, can automatically intercept the request, perform the login to service system(s) 30, and return the resulting information, using session related data accessed via a lookup from the authentication cookie. Notably, the authentication cookie allows a potential intruder to assume the identity of another user. For that reason, authentication cookies are only sent to a trusted authenticated user where required. The authentication cookie is protected while in transit by secure socket layers (SSL) and is preferably sent over only encrypted connections.

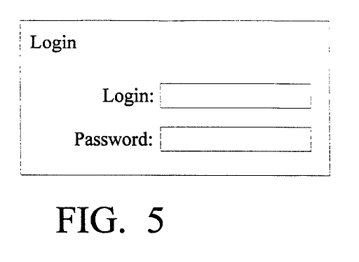

If an authentication cookie is not present, user-provider system module 54 presents a login screen at step S5. An exemplary login screen is shown in FIG. 5. At the login screen, user 8 enters a password and preferably, other authentication information such as a universal user name. For security, all information transmitted through provider system 10 is sent by service HTTP (HTTPS) using secure socket layers (SSL).

At step S6, user-provider system module 54 queries A/E database 21, 121 for user 8 confirmation. Of course, access is denied to system 10 where authentication does not occur. In this latter case, as shown at step S7, user 8 may be re-queried with the login screen for a set number of times, e.g., three, subject to lock-out of provider system 10. At that point, manual intervention for re-authorization to use provider system 10 may be required.

At step S8, once a successful sign-on occurs, an authentication cookie is created and forwarded to the user's system by interface system 40 and a user's entitlement level is attained from A/E database 21, 121. All subsequent requests from the user's browser include the authentication cookie, which is issued and stored by authentication system 44.

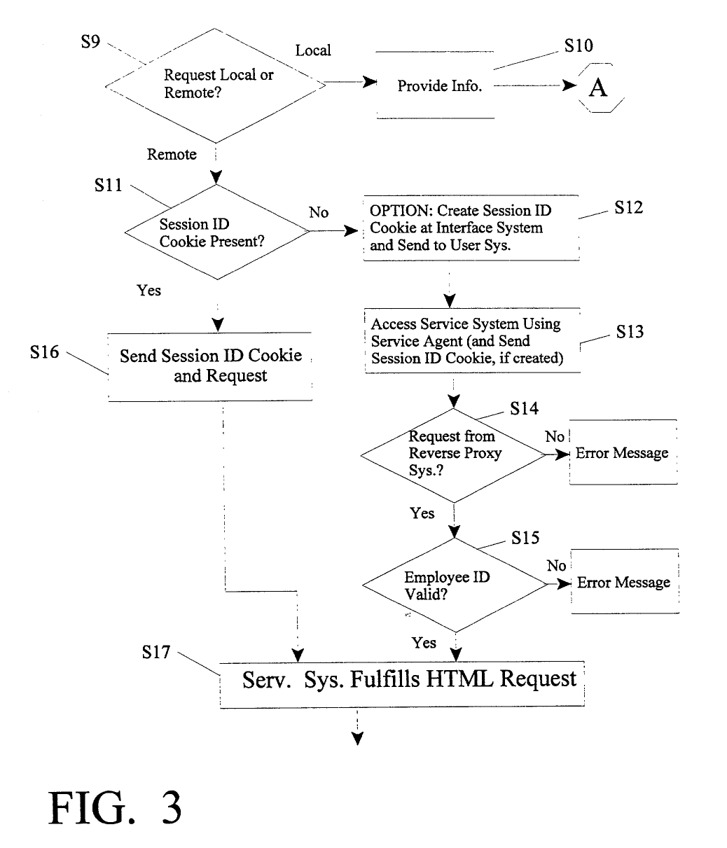

Beginning at step S9, shown in FIG. 3, user 8 interfaces with provider system 10 for benefit information. In this regard, interface system 40 receives a user request and determines whether the requested information is local to system 10, e.g., in user database 20, or must be obtained from a service system 30. For example, in the case of initial user 8 sign-on, information such as market news, stock quotes, etc., is obtained from a remote service system 30. This may be the case where a start interface or home page 101, as shown in FIG. 6, is built. However, some aspects of home page 101, e.g., frameset, may be local. If the information is local, browser interface system 40 provides the information to user 8, at step S10, after which logic cycles back to step S2 (FIG. 2). If the information is on service system 30, interface system 40 proceeds to step S11.

At step S11, user-service system module 56 of authentication system 44 is activated. User-service system module 56 determines if a session identifying cookie (“session ID cookie”) is present on user's system. This evaluation may occur for each service system 30 that must be accessed in order to respond to an information request. A session ID cookie is a file issued prior to or during (depending on what system issues the cookie) a user's 8 first visit to service system 30 and prevents interface system 40 from multiple log-on procedures after each request for information from service system 30. That is to say, the session ID cookie allows authentication system 44 to maintain the authentication of interface system 40 to a service system 30 between information requests, i.e., http transactions. A session ID cookie may also include temporary session information such as account balances, employee name and other data on a per-employee-session basis. In a preferred embodiment, a session ID cookie is valid only for a given user session and authentication is revoked after each session.

If a session cookie is present, authentication system 44 moves to step S16 where interface system 40, via reverse proxy system 46, forwards the session ID cookie to each appropriate service system 30 necessary to respond to the request. Session ID cookie indicates to each service system 30 that user 8 has been previously authenticated and may receive information. Logic then proceeds to step S17, discussed below.

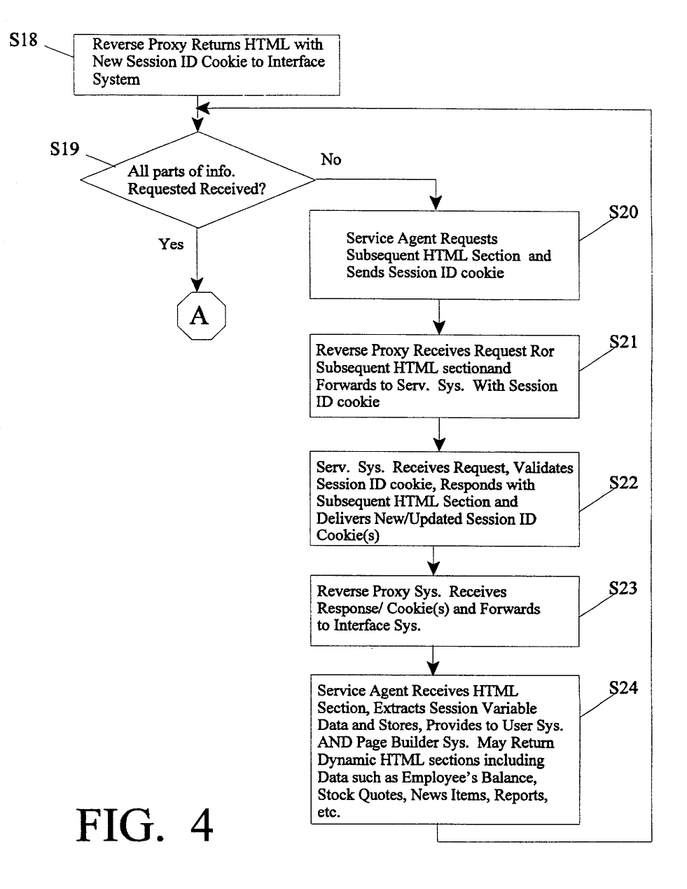

In the event that a session ID cookie is not present, logic branches to step S12, where interface system 40 creates a session ID cookie. However, as will be apparent relative to step S18 (FIG. 4), a session ID cookie may be sent to and cached on a user's system either by interface system 40 or service system 30 once service system 30 is accessed. Accordingly, step S12 is unnecessary where service system 30 creates its own session ID cookie.

At step S13, interface system 40, which passes requests and data through reverse proxy system 46, accesses the necessary service system 30 to obtain the requested information and may forward session ID cookie at this time. In a preferred embodiment, this activity is provided by interface system 40 initiating a modular session agent 48 for each service system 30 required to respond to an information request. Each service agent 48 includes the requisite knowledge and programming to download appropriate information, e.g., balance, number securities owned, etc., from the respective service system 30. This functionality may include logging onto and querying data from service system 30. During a sign-on by user 8, each entitled service system 30 is logged into by service agent 48 using appropriate user authentication identification/passwords in accordance with entitlement level data. This allows user 8 to simultaneously access a number of service systems 30.

Preferably, session agents 48 take the form of a Java bean. The modularity of service agent(s) 48 allows addition of future service systems 30 when necessary. To this end, in a preferred embodiment, a generic service agent application programming interface (SAAPI) is used to initially implement service agents. SAAPI provides bi-directional communication between a service system 30 and interface system 40. SAAPI provides the basic functionality for all service agents, e.g., retrieving appropriate user identifications/passwords from their entitlement levels for a respective service system, HTTP retrievals, cookie functionality and the like. This generic class is extended into individual service agents that provide functionality specific to a given service system 30, and is named after each service system for identification by interface system 40. Accordingly, the functionality offered by each service agent 48 may differ depending on the service system 30 and other factors. Service agent 48 dynamically integrates with interface system 40 in order to add services. It should be recognized that service agent 48 may be provided for each service system 30, or, where possible, a service agent 48 may be used to access more than one service system 30.

Alternative means of mutual authentication between interface system 40 and service systems 30 may exist. For example, bi-directional authentication by a secure sockets layer may be provided. In this case, an interface system 40 certificate is used for authentication by each individual service system 30. In this embodiment, passwords are not required and there is no need to remember all employee identifications/passwords, or synchronize passwords with the service systems 30. Advantageously, this embodiment does not compromise identifications/passwords after break-in attempts.

Referring back to FIG. 3 and the discussion of session ID cookies, where a session ID cookie is provided at step S12, it is created by user-service system module 56 of authentication system 44. If more than one service system 30 is accessed, a session ID cookie may be involved for each individual service system 30 so accessed. Conversely, each accessed service system 30 may not require a session ID cookie. This latter case may exist where service system 30 accepts a common session ID cookie; for example, when user-service system module 56 issues a session ID cookie acceptable to more than one service system 30.

Where user-service system module 56 issues a session ID cookie, interface system 40 may forward the cookie to a user system prior to step S13 (i.e., prior to accessing service system 30) and to service system 30 upon access thereof. Where service system 30 issues a session ID cookie, this is communicated to the user's system through reverse proxy system 46. All further requests for information from that service system 30 cause interface system 40, via reverse proxy system 46 to forward the session ID cookie to service system 30. Any new or updated session ID cookie is then returned by service system 30, as discussed below.

At step S14, service system 30 determines whether the request is from reverse proxy system 46 and if not, returns an error message.

At step S15, service system 30 ascertains the validity of the user identification and password. Where a negative response is received, an error message is generated.

Step S17 forwards an HTML response, and where applicable, may forward a new or updated session ID cookie to reverse proxy server 46. Page builder system 52 of application system 42 returns, in JavaScript Pages, any user variable data, e.g., balances, stock quotes (via included files), news items (via included files), reports, and the like to user 8. The new or updated session ID cookie is similar to that previously discussed, but may be more particular to service system 30. In addition, service system 30 also returns a service system session ID cookie (SSS ID cookie). That is to say, while user-service system module 56 or service system 30 creates a session ID cookie, service system 30 may require its own particular service system session ID cookie for authentication or for other reasons not pertinent to the present disclosure.

Turning now to step S18, shown in FIG. 4, the HTML response and cookie(s) pass through reverse proxy system 46 to interface system 40 and from there to the user's system. Any session ID cookie(s) are returned through interface system 40 via reverse proxy system 46 with subsequent requests for use by service system 30. As data passes through reverse proxy system 46 and interface system 40, certain session variable data may be stored for later use, e.g., cookies, employee balances, stock quotes, etc.

At step S19, interface system 40 determines whether the entire request has been received. In some instances, a request may require multiple section HTML responses from a single location, or multiple HTML responses from a number of locations. This may be the case, for example, where user 8 requests a retirement plan summary page having a welcome HTML section and a balance HTML section from a retirement plan system 34, such as shown in browser interface home page 101 in FIG. 6. If the determination is positive, i.e., the entire request received, operation returns to step S2 and awaits further request or a logoff indication from user 8.

If the determination is negative, i.e., the request includes multiple parts, operation passes to step S20, where the service agent 48 in for the particular service system 30 sends a request for a subsequent HTML section and cookie(s) to reverse proxy server 46.

Reverse proxy system 46 receives the request for the subsequent HTML section at step S21 and forwards this information to service system 30 with the appropriate cookie(s), e.g., session ID cookie and any SSS ID cookie.

Service system 30 receives the request at step S22, validates any cookie(s), and responds with the subsequent HTML section. In addition, service system 30 delivers a new or updated session ID cookie and/or new or updated SSS ID cookie where required.

Where proper validation occurs, reverse proxy system 46 receives the response and cookie(s) and forwards them to interface system 40 at step S23.

Next, the service agent 48 for the particular service system 30 receives the subsequent HTML section and cookie(s) and stores any data that may change as a session variable, e.g., balances, stock quotes, etc., and provides the information to the user system (step S24). Thereafter, logic returns operation to step S19, where steps S19-S24 are repeated until complete. Page builder system 52 returns user variable data, e.g., balances, stock quotes (via included files), news items (via included files), reports, and the like in JavaScript pages.

After this procedure is completed, operation returns to step S2 to await further requests or a logoff indication. Where interface system 40 has not received a request from user 8 within a given time period, timer system 50 causes interface system 40 to revoke that user's session. Once revoked, user 8 is unable to connect to service system 30.

More particularly, each individual service system 30 is unable to revoke a user session as this causes user 8 to continue a valid session with interface system 40, while unable to interact with a particular service system 30. Interface system 40 is the only means allowed to revoke a session, for example, where user 8 decides to logoff. However, under certain circumstances it may be possible for a session to become invalid even where interface system 40 session is still valid. For example, interface system 40 changes the “session invalid/expired” error that service system 30 generally displays to redirect to the service login page, i.e., provide the absolute URL to the reverse proxy system 46. This causes user 8 to request the page from reverse proxy system 46. In this instance, authentication system 44 catches the request, performs an automatic login, and user 8 receives the main page of the particular service system 30 of interest. After login is successful, user 8 is then automatically redirected to the referring page, i.e., the page originally requested before invalidation.

Referring back to FIG. 1, application system 42 is responsible for interfacing with browser interface system 40 to handle certain dynamic Web requests such as servlets, JavaScript pages.

Turning now to FIGS. 6-9, browser interface 100 is illustrated. Browser interface 100 delivers content in accordance with a user entitlement level. Accordingly, interface 100 provides a means by which user 8 may access a multitude of benefit information from varied locations using a single sign-on user name and password. As previously mentioned, two exemplary service systems include an employer corporate stock plan system 32 and an employee retirement plan system 34 (FIG. 1).

Referring first to FIG. 6, a start interface or home page 101 of browser interface 100 acts as an introductory display for user 8 upon authentication. From start interface 101, user 8 may summarily review benefits, obtain financial information, and monitor market activity. Further information may be accessed by making selections from start interface 101, as will be described below. Preferably, browser interface 100 also includes personalized employee data such as employee name 126, date, employer name 130, etc. In addition, browser interface 100 includes personalized data in the form of information regarding user's holdings as outlined below.

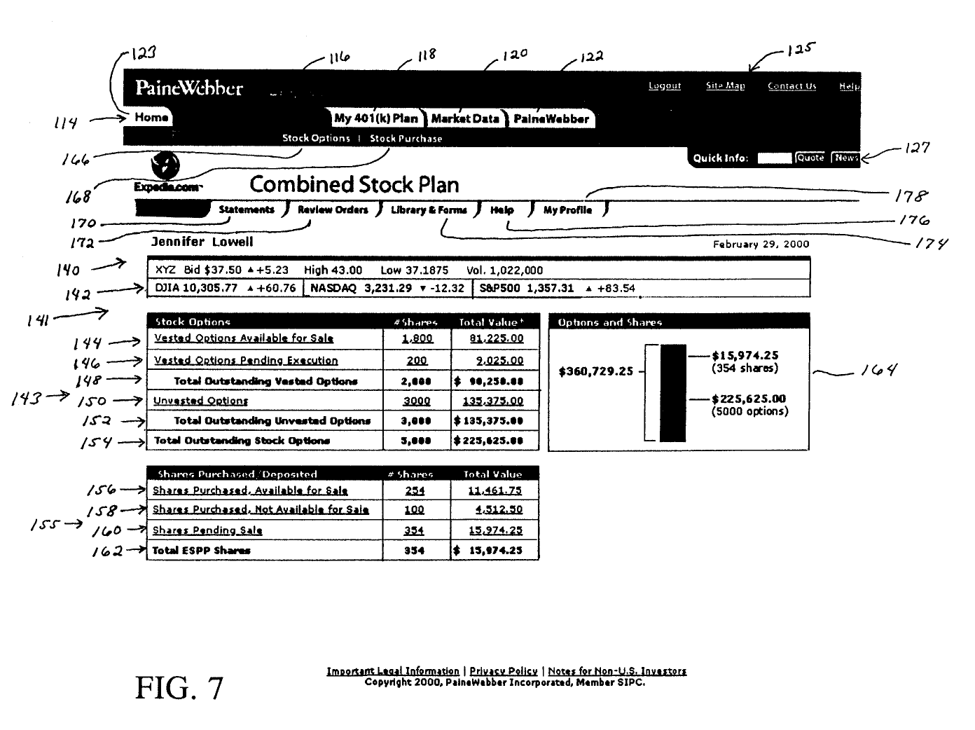

Start interface 101 includes a welcome section 102; user plan summary section 104; a market data section 106; a polling or questionnaire section 108; an employer benefit provider section 110; a stock watch list section 112 and a life stages section 113. Features and specific information are provided by accessing provider system 10 and/or service system 30. Preferably, browser interface 100 is provided as a frameset on provider system 10. Welcome section 102 provides a brief introduction to the site including links to New Features and information related to the user's benefit package with a link to Plan Holdings, shown in FIG. 7.

User plan summary section 104, called ‘My Plan’ section, preferably provides a summary of the market valuation of the user's holdings. The data is obtained from user data residing within the respective service system 30, e.g., corporate stock plan system 32 and retirement plan system 34. If a user has more than one plan type, e.g., corporate stock plan, retirement plan, etc., a total value sum is computed. Similarly, if user 8 has more than one type of benefit within a plan, e.g., stock options and grants, total plan value is computed. In this instance, exemplary data includes the number of outstanding stock options and value; number of user employer stock plan shares and value; number of user restricted shares and value; total number shares and total value of user stock benefit plan; user retirement plan balance; combined value of user stock plan and retirement plan.

Market data section 106 provides data regarding financial markets, e.g., Dow Jones, in moving indices and/or news format. A polling section 108, called “Financial Checkup” in the example provided, allows a benefit provider to test a user's financial status or collect other useful information. Preferably, a first question of a multi-question poll is provided. Selection of “continue with Financial Checkup” leads user 8 to the rest of the poll. Employer benefit provider section 110 provides an area for a benefit provider to market services. For example, FIG. 6 shows two abstracts of press releases, announcements and links to featured articles related to the benefits provider. The abstracts may contain links to the full content. Watch list 112 provides a list of securities and market status for securities selected by user 8. The list is stored as part of a user's data and is automatically updated every time start interface 101 is launched or refreshed by user 8.

Life stages section 113 provides a menu of life stage or event selections for selecting appropriate financial service information. Each selection provides information particular to the life stage. For example, information on “Death” may relate to wills, estate taxes, and the like. Exemplary life stages include marriage, child, new home, death, divorce or separation, retirement, moving, caring for aging parents, empty nest, long-term illness, coming into money, sabbatical, etc.

Any interface of browser interface 100 may include a number of base selections 114 for accessing various features, information and at least one service system 30. For instance, start interface 101, shown in FIG. 6, includes a corporate stock plan selection 116; a retirement plan selection 118; a market data selection 120; an employer benefit provider selection 122 for directly accessing an employer benefit provider's site; and a home selection 123 for returning to start interface 101. Additional selections may also be provided, e.g., specified employer benefit provider selections 124, browser system function selections 125 such as logout, site map, contact us, help, etc. and Quick Info instant quote/news selections 127. The selections provided may be determined by a user's entitlement level. For example, where user 8 does not participate in a retirement plan, this selection 118 would not be provided.

Referring to FIG. 7, a corporate stock plan interface 140 is shown. Interface 140 is provided in response to selection of corporate stock plan selection 116 from browser interface 100. The information provided by interface 140 is in accordance with corporate stock plan system 32. As a brief overview, reference is made to FIG. 7 where a combined stock plan interface 141 of corporate stock plan interface 140 is shown. User 8 may view stock options or purchase by selecting stock options selection 166 or stock purchases selection 168.

Combined stock plan interface 141 provides information regarding a myriad of different types of securities provided by a corporate stock plan, e.g., options, shares, etc. The information may include a real time market data window 142 for displaying data regarding the employer corporate stock, a stock options application 143 and a shares application 155. Stock options application 143 may provide number of vested options available for sale and value 144, number of vested options pending execution and value 146, total number outstanding vested options and value 148, number of unvested options and value 150, and total number of outstanding unvested options and value 152; total number outstanding stock options and value 154. Shares application 155 may provide number of shares purchased, available for sale and value 156, number of shares purchased, not available for sale and value 158, number of shares pending sale and value 160, and total number corporate stock plan shares and value 162. In addition, a graphical representation 164 of a user's stock portfolio may be provided. Using combined stock plan interface 141, user 8 can receive detailed corporate stock plan information. Each underlined parameter of stock operation application 143 and shares application 155 may be a hypertext link, selection of which will provide more detailed parameter information.

Additional features of combined stock plan interface 141 may include, for instance, a statements selection 170, a review orders selection 172, a library & forms selection 174, a help selection 176, and a my profile selection 178.

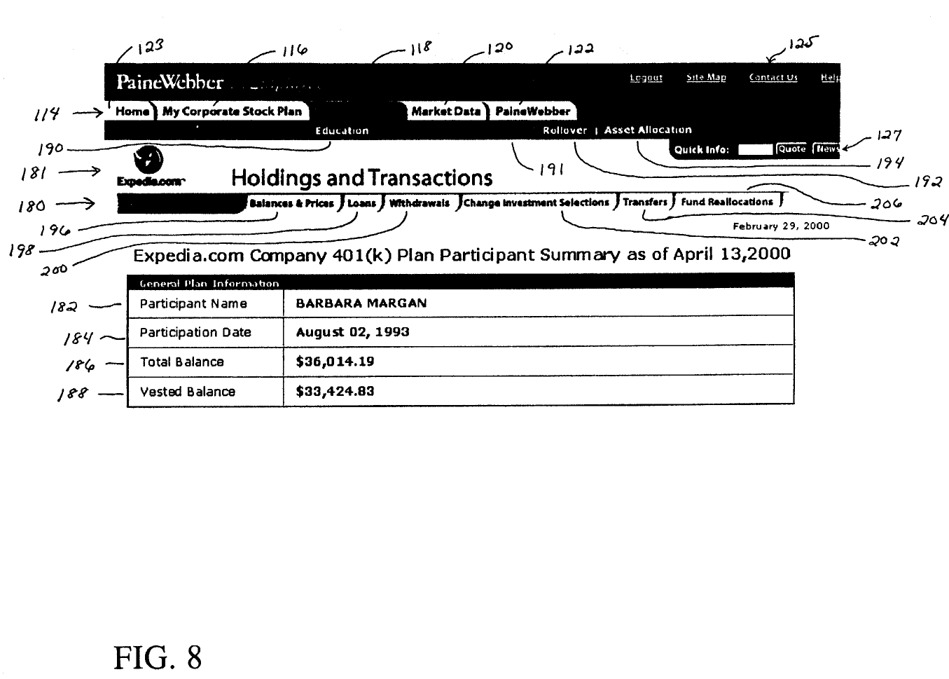

Referring now to FIG. 8, a retirement plan interface 180 of retirement plan system 34 is shown. As a brief overview, interface 180 includes an education selection 190 for providing educational information about the retirement plan, a holdings and transactions selection 191 (interface shown), a rollover selection 192 for providing information about rolling over of other retirement accounts into the retirement plan, and an asset allocation selection 194 which provides retirement fund information.

Holdings and transaction interface 181 (“HT interface 181”) provides detailed retirement plan information. Exemplary information includes user name 182, participation date 184, total balance 186 and vested balance 188. Additional features include a balances & prices selection 196, a loans selection 198, a withdrawals selection 200, a change investment selections selection 202, a transfers selection 204, and a fund reallocation selection 206.

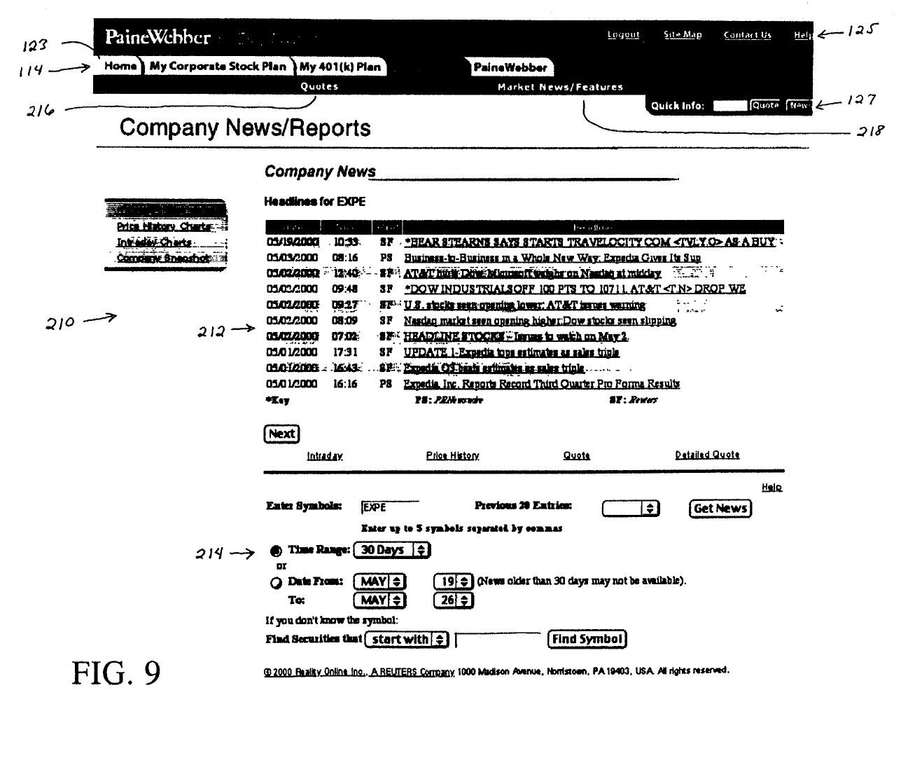

FIG. 9 illustrates a market data interface 210 and, in particular, a company news/reports interface 211. Market data interface 210 is provided in response to selection of market data section 106 from browser interface 100. Information provided by interface 210 may be provided from other service systems 36, e.g., CBS MarketWatch, Reuters, etc.

Company/news interface 210 provides detailed market information for the user's employer, e.g., EXPE. Interface 210 may also include a news headlines section 212 and an input section 214 to input a stock symbol(s), a time frame for headlines or search for a security. Other available selections may include a quote selection 216 for obtaining a stock quote only and market news/features selection 218 for obtaining news and information on the market in general.

It should be recognized that the features presented to user 8 via browser interface 100 will depend on the particular employee benefits and the user's entitlement level. Moreover, other standard website and/or browser features may be provided, e.g., login, logout, forgot password, change password, etc.

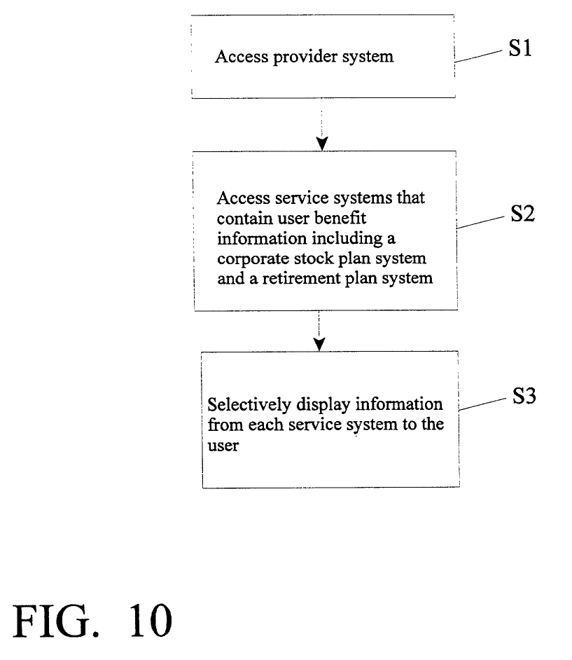

Referring to FIG. 10, a method of accessing employee benefit information using the above systems is shown. In a first step S1, provider system 10 is accessed. At step S2, the employee benefit provider system accesses a plurality of service systems that contain benefit information including a corporate stock plan system and a retirement plan system. Finally, in step S3, information from each service system regarding the user's benefits is selectively displayed.

Having thus described the invention in rather full detail, it will be recognized that such detail need not be strictly adhered to but that various changes and modifications may suggest themselves to one skilled in the art, all falling within the scope of the invention, as defined by the subjoined claims.

What is claimed is:

1. A benefits system comprising:
an employer system accessible by an employee; and
a benefit provider system accessible from the employer system wherein the benefit provider system includes an interface system for accessing a plurality of service systems including at least an employer corporate stock plan system and a retirement plan system.

2. The system as recited by claim 1, wherein the interface system determines employee entitlements to the service system.

3. The system as recited by claim 2, wherein the interface system provides access to the service system using a single logon process.

4. The system as recited by claim 1, wherein the interface system includes an authentication system configured to authenticate a user to the benefit provider system, and the benefit provider system to the service systems.

5. The system as recited by claim 4, wherein the authentication system includes:
a user-provider system module configured to determine whether a user has been authenticated by the benefit provider system; and
a user-service system module configured to determine whether the benefit provider system has been authenticated by a particular service system.

6. The system as recited by claim 5, wherein the user-provider system module and the user-service system module check a user's system for the presence of a cookie.

7. The system as recited by claim 1, wherein the interface system includes a service agent for communicating with the service system.

8. The system as recited by claim 7, wherein the interface system includes a service agent for each benefit system.

9. The system as recited by claim 1, wherein the interface system includes a reverse proxy system for seamless communication to a service system.

10. The system as recited by claim 1, further comprising an application system configured to provide dynamic content to a user.

11. The system as recited by claim 1, wherein the benefit provider system creates a browser interface for displaying data from the service systems.

12. The system as recited by claim 1 1, wherein the browser interface includes personalized user data.

13. The system as recited by claim 12, wherein the personalized data includes at least one of a user name; number of user outstanding stock options and value; number of user employer stock plan shares and value; number of user restricted shares and value; total number shares and total value of employee stock benefit plan; user retirement plan balance; combined value of user stock plan and retirement plan; and employer name.

14. The system as recited by claim 11, wherein the browser interface includes real time market data.

15. The system as recited by claim 11, wherein the browser interface includes employer benefit provider information.

16. The system as recited by claim 11, wherein the browser interface includes an employer corporate stock plan system selection and an employee retirement plan selection.

17. The system as recited by claim 1 1, wherein the browser interface includes a life stages selection menu.

18. The system as recited by claim 1, wherein the browser interface displays a combined stock plan interface of the employer corporate stock plan system.

19. The system as recited by claim 18, wherein the combined stock plan interface includes a stock options application and a shares application.

20. The system as recited by claim 19, wherein the stock options application provides a number of vested options available for sale and value; a number of vested options pending execution and value; a number of total outstanding vested options and value; a number of vested options and value; a number of total outstanding unvested options and value; and a number of total outstanding stock options and value.

21. The system as recited by claim 19, wherein the shares application provides a number of shares purchased, available for sale and value; a number of shares purchased, not available for sale; a number of shares pending sale and value; and a number of total corporate stock plan shares and value.

22. The system as recited by claim 18, wherein the combined stock plan interface includes a real time market data window for displaying data regarding the employer corporate stock plan system.

23. The system as recited by claim 1, wherein the browser interface displays a retirement plan interface of the retirement plan system, the retirement plan interface having an education selection, a holdings and transactions selection, a rollover selection and an asset allocation selection.

24. A benefits provider system for delivering user benefit information, the system comprising:
means for connecting the user, with a single sign-on, to at least two service systems including:
a retirement plan system; and
a corporate stock plan system; and
means for delivering content from the service systems to the user.

25. The system as recited by claim 24, further comprising an online transaction forum benefit system.

26. The system as recited by claim 24, wherein the means for connecting includes an authentication database for storing employee identifiers, entitlement level and personal data.

27. The system as recited by claim 26, wherein the entitlement level determines the service systems accessed.

28. The system as recited by claim 24, further comprising means for delivering dynamic content to a user.

29. The system as recited by claim 24, wherein the service system is remote relative to the system.

30. The system as recited by claim 24, wherein the service system is local relative to the system.

31. A method of accessing user benefit information comprising the steps of:
accessing a benefit provider system;
interfacing the benefit provider system with a plurality of service systems including at least a corporate stock plan system and a retirement plan system; and
selectively displaying information from the service system to a user.
